(19) United States
(12) Patent Application Publication
(10) Pub. No.: US 2010/0147803 A1
(43) Pub. Date: Jun. 17, 2010

(54) PROCESS FOR REMOVING METALLIC MATERIAL FROM CASTED SUBSTATES, AND RELATED COMPOSITIONS

(75) Inventors: Lawrence Bernard Kool, Clifton Park, NY (US); Michael Francis Xavier Gigliotti, Scotia, NY (US); Shyh-Chin Huang, Latham, NY (US); Gabriel Kwadwo Ofori-Okai, Niskayuna, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/334,582

(22) Filed: Dec. 15, 2008

(51) Int. Cl. C23F 1/16; C09K 13/04

(52) U.S. Cl. 216/109; 252/79.2

(57) ABSTRACT

A method for removing a metallic material from the surface of a casted substrate includes the step of contacting the metallic material with an aqueous composition which comprises an acid having the formula HₓAF₆, or precursors to said acid. “A” in the formula is selected from the group consisting of Si, Ge, Ti, Zr, Al, and Ga; and x is 1-6.

### FIELD OF THE INVENTION

In a general sense, this invention relates to casted articles. More specifically, it pertains to methods and compositions useful for removing metallic material from the surface of casted substrates, e.g., turbine engine components.

### BACKGROUND OF THE INVENTION

Liquid metal cooling is often used to form high-gradient castings of superalloy components in advanced gas turbines, as well as other industrial parts. During the cooling process, some of the molten metal used to cool the casting can breach the casting container and be deposited as a contaminant on the surface of the casted article. The casted article is typically subjected to a series of thermal fabrication and heat treatment cycles before becoming a useful casted article. The metal contaminant, if present, can diffuse below the surface of the casted item during the thermal processing cycles, and precipitously affect the surface quality and bulk properties of the finished article.

Accordingly, there is a need for methods of effectively removing such metallic contaminants. It would also be desirable if the processes did not result in the formation of an unacceptable amount of hazardous fumes. The processes should also exhibit some degree of selectivity. For example, they should effectively remove the metallic contaminant while substantially preserving the casted substrate.

### BRIEF DESCRIPTION OF THE INVENTION

In one embodiment of this invention, a method for removing a metallic material from the surface of a casted substrate includes the step of contacting the metallic material with an aqueous composition which comprises an acid having the formula HₓAF₆, or precursors to said acid. “A” in the formula is selected from the group consisting of Si, Ge, Ti, Zr, Al, and Ga; and x is 1-6.

In another embodiment, a method for removing a metallic substance from the surface of a casted substrate comprises the step of immersing the casted substrate in an aqueous composition which comprises (a) about 0.05 M to about 5 M of an acid having the formula HₓAF₆, wherein A is selected from the group consisting of Si, Ge, Ti, Zr, Al, and Ga; and x is 1-6; (b) about 0.1 M to about 20 M of a phosphorous-containing compound or mixture thereof; and (c) about 0.3 M to about 1 M of hydrochloric acid or nitric acid.

In another embodiment, an aqueous composition for removing a metallic material from the surface of a casted substrate, comprises (a) about 0.05 M to about 5 M of an acid having the formula HₓAF₆, wherein A is selected from the group consisting of Si, Ge, Ti, Zr, Al, and Ga; and x is 1-6; (b) about 0.1 M to about 1 M of a phosphorous-containing compound; and (c) about 0.3 M to about 1 M of hydrochloric acid or nitric acid.

In yet another embodiment, an aqueous composition for removing a metallic material from the surface of a casted substrate, comprises (a) about 0.05 M to about 5 M of an acid having the formula HₓAF₆, wherein A is selected from the group consisting of Si, Ge, Ti, Zr, Al, and Ga; and x is 1-6; and (b) about 0.3 M to about 1 M of nitric acid.

Other features and advantages of the present invention will be apparent from the following detailed description.

### DETAILED DESCRIPTION OF THE INVENTION

Disclosed herein are methods for removing a metallic material from the surface of a casted substrate. The method includes the step of contacting the metallic material with an aqueous composition. As used herein, a “metallic material” is a material which is primarily comprised of metal or metal alloys, and is deposited on the casted substrate surface in excess of any amount of the material which may be present in the casted substrate. Non-limiting examples of metallic materials are those which comprise at least one element selected from the group consisting of tin, iron, cobalt, nickel, aluminum, chromium, titanium, and mixtures which include any of the foregoing, e.g., stainless steel. The metallic material may include other modifying constituents co-deposited with the metal or metal alloy, such as silicon, zirconium, yttrium and oxygen.

As used herein, the term “removal of the metallic material” is meant to refer to the severe degradation of the metallic material, leaving at most only a metallic material residue which weakly adheres to the underlying substrate surface. The residue is easily removed by a subsequent, conventional technique such as “de-smutting”, as discussed below.

In many embodiments, the method of this invention has a very desirable degree of selectivity. In other words, the metallic material can be effectively removed from the casted substrate surface, without adversely affecting or damaging the substrate. This is an important advantage for preserving the structural integrity and dimensions of the casted substrate. Moreover, the treatment composition described herein is relatively benign, from an environmental standpoint, as compared to mineral acid-based compositions.

The thickness of the metallic material deposited on the substrate surface will depend on various factors, such as the type of substrate being cast, the casting technique employed, the materials being employed, etc. In one embodiment, the metallic material may have a thickness between about 2 microns and about 2000 microns. In another embodiment, the metallic material may have a thickness between about 5 microns and about 1000 microns. In yet another embodiment, the metallic material may have a thickness between about 10 microns and about 500 microns.

In one embodiment, the metal contaminant is deposited on the surface of the casted substrate as a result of the ingression of liquid metal during the casting process. The ingression of liquid metal may occur when the mold that contains the casted substrate cracks while the mold is still immersed in a liquid metal bath. When the mold cools and develops cracks while still in the liquid metal bath, the liquid metal can flow along the cracks in the mold and eventually make contact with the surfaces of the casted substrate inside the mold. The liquid metal can react with the interior of the mold while flowing through the mold cracks and with the substrate material while in contact with surfaces of the casted substrate. For this reason, some elements in the casting mold and in the casted substrate may also be present in the metal contaminant due to the interaction of the ingressed liquid metal with the casting mold and casted substrate materials.

The aqueous composition for this invention includes an acid having the formula HₓAF₆. In this formula, A is selected from the group consisting of Si, Ge, Ti, Zr, Al, and Ga. The subscript x is a quantity from 1 to 6, and more typically, from 1 to 3. Materials of this type are available commercially, or can be prepared without undue effort. The HₓAF₆ compound, sometimes referred to herein as the “primary acid”, is preferably H₂SiF₆ or H₂ZrF₆, or mixtures thereof. In some embodiments, H₂SiF₆ is especially preferred. The compound H₂SiF₆ is referred to by several names, such as “fluosilicic acid”, “hydrofluosilicic acid”, “fluorosilicic acid”, and “hexafluorosilicic acid”.

Precursors to the HₓAF₆ acid may also be used. As used herein, a “precursor” refers to any compound or group of compounds which can be combined to form the acid or its dianion AF₆⁻², or which can be transformed into the acid or its dianion under reactive conditions, e.g. the action of heat, agitation, catalysts, and the like. Thus, the acid can be formed in situ in a reaction vessel, for example.

As one illustration, the precursor may be a metal salt, inorganic salt, or an organic salt in which the dianion is ionically bound. Non-limiting examples include salts of Ag, Na, Ni, K, and NH₄⁺, as well as organic salts, such as a quaternary ammonium salt. Dissociation of the salts in an aqueous solution yields the acid. In the case of H₂SiF₆, a convenient salt which can be employed is Na₂SiF₆.

In one embodiment, H₂SiF₆ can be formed in situ, for example, by the reaction of a silicon-containing compound with a fluorine-containing compound. An exemplary silicon-containing compound is SiO₂, while an exemplary fluorine-containing compound is hydrofluoric acid, i.e., aqueous hydrogen fluoride.

When used as a single acid, the HₓAF₆ acid can be somewhat effective for removing the chromide coating. The preferred level of acid employed will depend on various factors, such as the type and amount of coating being removed; the location of the coating material on a substrate; the type of substrate; the thermal history of the substrate and coating, e.g., the level of interdiffusion; the technique by which the substrate is being exposed to the treatment composition as described below; the time and temperature used for treatment; and the stability of the acid in solution.

In general, the HₓAF₆ acid is present in a treatment composition at a level in the range of about 0.05 M to about 5 M, where M represents molarity. Molarity can be readily translated into weight or volume percentages, for ease in preparing the solutions. Usually, the level is in the range of about 0.2 M to about 3.5 M. In the case of H₂SiF₆, a preferred concentration range is often in the range of about 0.2 M to about 2.2 M. Longer treatment times and/or higher treatment temperatures, described below, may compensate for lower levels of the acid, and vice versa. Adjustment of the amount of HₓAF₆ acid, and of other components described below, can readily be made by observing the effect of particular compositions on coating removal from the substrate.

In preferred embodiments, the treatment composition also includes at least one additional acid or “second acid”, or precursor thereof. The additional or “second” acid is preferably a phosphorous-containing compound, or nitric acid. Non-limiting examples of the phosphorous compounds include phosphoric acid and phosphorous acid, as well as mixtures thereof. In general, the phosphorous compounds are commercially available, as is nitric acid. These compounds can also be synthesized by well-known techniques.

Those skilled in the art can select the most appropriate additional acid, based on observed effectiveness and other factors, such as availability, compatibility with the primary acid, cost, and environmental considerations. Moreover, a precursor of the acid may be used, such as a salt, as described above in reference to the primary acid. For most embodiments, the preferred additional acid is a phosphorous compound, with phosphoric acid being especially preferred.

The present inventors do not wish to be bound to any particular theory in regard to the unexpected efficacy of the phosphorous compounds and nitric acid. However, they appear to provide the acidic capacity to rapidly oxidize the metal in the metallic material. This in turn appears to induce the metallic material to become solubilized, and to readily detach from the casted substrate surface region.

The amount of additional acid employed, i.e., the phosphorous compound or nitric acid, will depend on the acid itself, as well as the identity of the primary acid, and on many of the factors set forth above. Phosphorous compounds are usually present in the composition at a level in the range of about 0.1 M to about 20 M. In some preferred embodiments, e.g. in the case of phosphoric acid, the preferred range is from about 0.5 M to about 5 M. Furthermore, some preferred embodiments contemplate a range of about 2 M to about 4 M.

When present as the additional acid, nitric acid is present at a level which will minimize degradation of casted substrates being treated according to this invention. Usually that level will be no greater than about 1.2 M. In preferred embodiments, the range will be from about 0.3 M to about 1 M.

In some embodiments, the treatment composition includes a minor amount of a third acid. This constituent is usually a strong acid, having a pH of less than about 3.5 in pure water. Thus, the third acid can be nitric acid, i.e., when the second acid is a phosphorous compound. Non-limiting examples of other strong mineral acids are sulfuric acid, hydrochloric acid, hydrofluoric acid, hydrobromic acid, hydriodic acid, perchloric acid, alkyl sulfonic acids, and mixtures of any of the foregoing. The strong acid appears to be especially useful for removing portions of the metallic material which may have diffused into the casted substrate.

In one embodiment, the third acid comprises hydrochloric acid, nitric acid, or mixtures thereof. In a preferred embodiment, the third acid is hydrochloric acid. Typically, the acid is advantageously supplied and used in aqueous form, e.g., 35-38 percent hydrochloric acid in water.

The amount of third acid employed will depend on the identity of the primary acid and the second acid, and on many of the factors set forth above. To minimize degradation of some substrates, the third acid is preferably present at the levels described above, in regard to nitric acid. Thus, the concentration of the acid in the treatment composition is usually no greater than about 1.2 M, and preferably in the range of about 0.3 M to about 1 M. Experiments can be readily carried out to determine the most appropriate level for the third acid. The process of the invention is generally free of problems typically associated with methods which require relatively large amounts of strong acids.

The aqueous composition of the present invention may include various other additives which serve a variety of functions. Non-limiting examples of these additives are inhibitors, dispersants, surfactants, chelating agents, wetting agents, deflocculants, stabilizers, anti-settling agents, reducing agents, and anti-foam agents. Those of ordinary skill in the art are familiar with specific types of such additives, and with effective levels for their use. An example of an inhibitor for the composition is a relatively weak acid like acetic acid. Such a material tends to lower the activity of the primary acid in the composition. This is desirable in some instances, e.g., to decrease the potential for pitting of the surfaces of some types of casted substrates, if contacted with the treatment composition.

Various techniques can be used to treat the casted substrate with the aqueous composition. For example, the casted substrate can be continuously sprayed with the composition, using various types of spray guns. A single spray gun could be employed. Alternatively, a line of guns could be used, and the casted substrate could pass alongside or through the line of guns, or multiple lines of guns. In another alternative embodiment, the oxide-removal composition could be poured over the casted substrate and continuously recirculated.

In preferred embodiments, the casted substrate is immersed in a bath of the aqueous composition. Immersion in this manner, in any type of vessel, often permits the greatest degree of contact between the aqueous composition and the metallic material being removed. Immersion time and bath temperature will depend on various factors, some of which were described above. These factors include the particular type of metallic material being removed, the acid or acids being used in the bath, and equipment capabilities. Usually, the bath is maintained at a temperature in the range of about room temperature to about 100 degrees Celsius, while the substrate is immersed therein. In preferred embodiments, the temperature is maintained in the range of about 45 degrees Celsius to about 95 degrees Celsius.

The immersion time in the bath may vary considerably. It is usually in the range of about 10 minutes to about 72 hours, and preferably, from about 1 hour to about 20 hours. Longer immersion times may compensate for lower bath temperatures.

Treatment of the casted substrate in the stripping bath severely degrades the integrity of the metallic material being removed. The degraded metallic material is referred to herein as “smut” or “metallic material residue”. The metallic material residue often continues to weakly adhere to the underlying casted substrate or sublayer. Consequently, the treatment is usually followed by a post-stripping step, often referred to as a “de-smutting” operation. Such a step is known in the art, and described in various references. It may be in the form of a gentle abrasion step which minimizes damage to the casted substrate or the underlying sublayer. As one example, grit-blasting can be carried out by directing a pressurized air stream containing aluminum oxide particles across the substrate surface. The air pressure is usually less than about 100 psi. The grit-blasting is carried out for a time period sufficient to remove the degraded coating. The duration of grit-blasting in this embodiment will depend on various factors, such as the thickness and specific composition of the smut layer; the size and type of grit media, and the like. The process is typically carried out for about 30 seconds to about 3 minutes.

Other known techniques for abrading the surface may be used in lieu of grit-blasting. For example, the substrate surface can be manually scrubbed with a fiber pad, e.g. a pad with polymeric, metallic, or ceramic fibers. Alternatively, the substrate surface can be polished, for example, with a flexible wheel or belt in which alumina or silicon carbide particles have been embedded. Liquid abrasive materials may alternatively be used on the wheels or belts. These alternative techniques should be controlled in a manner that maintains a contact force against the substrate surface that is no greater than the force used in the grit-blasting technique discussed above.

Other techniques, or combinations of techniques, can be employed in place of abrasion, to remove the degraded metallic material. Examples include laser ablation of the substrate surface, or tumbling of the casted substrate, including water-tumbling. Alternatively, the degraded material could be scraped off the substrate surface. As still another alternative, sound waves, e.g. ultrasonic waves, could be directed against the surface, causing vibrations which can shake loose the degraded material. For each of these alternative techniques, those skilled in the art would be familiar with operating adjustments which are made to control the relevant force applied against the surface of the casted substrate, as in the case of the abrasion technique, to minimize damage to the substrate or sublayer being preserved. The article is sometimes rinsed after this step, e.g., using water or a combination of water and a wetting agent.

The metallic material being removed by this process is one which has been deposited on the surface of a variety of casted substrates. The casted substrate may comprise metal, or metal alloys. In one embodiment, the casted substrate comprises iron, cobalt, nickel, aluminum, chromium, titanium, and mixtures or alloys which include any of the foregoing, e.g. stainless steel.

Very often, the casted substrate comprises a superalloy. The superalloy is typically nickel, cobalt, or iron-based, although nickel and cobalt-based alloys are favored for high-performance applications. Illustrative nickel-base superalloys include at least about 40 weight percent Ni, and at least one component from the group consisting of cobalt, chromium, aluminum, tungsten, molybdenum, titanium, and iron. Illustrative cobalt-base superalloys include at least about 30 weight percent Co, and at least one component from the group consisting of nickel, chromium, aluminum, tungsten, molybdenum, titanium, and iron.

It should be apparent from the preceding description that another embodiment of this invention is directed to a stripping composition for removing a metallic material from a casted substrate surface. As described herein, the casted surface is often a component of a turbine engine, e.g., an airfoil, a blade or “bucket”. The treatment composition includes the HₓAF₆ compound described above. In preferred embodiments, the composition also includes the phosphorous-containing compound, and limited amounts of a strong acid like hydrochloric acid. Various other additives can be present in the composition. It is typically used in the form of bath, in which the part being treated is immersed.

### EXAMPLES

The example which follows is merely illustrative, and should not be construed to be any sort of limitation on the scope of the claimed invention.

### Example 1

A piece of a nickel-based superalloy article cast by a liquid-tin-cooled directional solidification process is obtained. The superalloy article comprises 7.5 weight percent cobalt, 7.0 weight percent chromium, 6.2 weight percent aluminum, 6.5 weight percent tantalum, 1.5 weight percent molybdenum, 5.0 weight percent tungsten, 3.0 weight percent rhenium, trace amounts of hafnium, yttrium, boron and carbon, with the balance being nickel. A deposit of metal contaminant having a thickness of about 500 microns is located on the surface of the casted superalloy substrate. The metal contaminant is primarily comprised of tin, due to the ingression of liquid tin during the casting process. The ingression of liquid tin occurs in a liquid-tin-cooled directional solidification process when the mold containing the casted superalloy substrate cracks while the mold is still immersed in the liquid tin bath. The liquid tin bath is uniquely equipped in a liquid-tin-cooled directional solidification furnace which provides more efficient cooling than a conventional radiation-cooled directional solidification furnace. As the mold cools, it develops cracks while still in the liquid tin bath. The liquid tin flows along the cracks in the mold and makes contact with the surfaces of the casted substrate inside the mold. The liquid tin can react with the interior of the mold while flowing through the mold cracks and with the superalloy while in contact with the casted substrate surface. As a result, some elements in the casting mold and in the casted substrate may also be present in the metal contaminant. The contaminated casted substrate is immersed in a bath of an aqueous composition comprising commercially available grades of approximately 71 volume percent hydrofluosilicic acid (H₂SiF₆), 24 volume percent phosphoric acid (H₃PO₄), and 5 volume percent hydrochloric acid (HCl). The bath is maintained at a temperature of 80 degrees Celsius, while the substrate is immersed in the aqueous composition for 4 hours. The metal contaminant is substantially removed by the aqueous acid composition after the 4 hour immersion.

All ranges disclosed herein are inclusive of the endpoints, and the endpoints are combinable with each other. The terms “first,” “second,” and the like as used herein do not denote any order, quantity, or importance, but rather are used to distinguish one element from another. The modifiers “about” and “approximately” used in connection with a quantity are inclusive of the stated value and have the meaning dictated by the context (e.g., includes the degree of error associated with measurement of the particular quantity). The use of the terms “a” and “an” and “the” and similar referents in the context of describing the invention (especially in the context of the following claims) are to be construed to cover both the singular and the plural, unless otherwise indicated herein or clearly contradicted by context.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed:

1. A method for removing a metallic material from the surface of a casted substrate, comprising the step of contacting the metallic material with an aqueous composition which comprises an acid having the formula HₓAF₆, or precursors to said acid, wherein A is selected from the group consisting of Si, Ge, Ti, Zr, Al, and Ga; and x is 1-6.

2. The method of claim 1, wherein x is 1-3.

3. The method of claim 1, wherein the acid is present in the composition at a level in the range of about 0.05 M to about 5 M.

4. The method of claim 3, wherein the acid is present in the composition at a level in the range of about 0.2 M to about 3.5 M.

5. The method of claim 1, wherein the precursor is a salt of the acid.

6. The method of claim 1, wherein the aqueous composition comprises the compound H₂SiF₆ or H₂ZrF₆.

7. The method of claim 1, wherein the aqueous composition further comprises at least one additional acid or precursor thereof.

8. The method of claim 7, wherein the additional acid comprises nitric acid or a phosphorous-containing compound.

9. The method of claim 8, wherein the additional acid comprises a phosphorous-containing compound, and the phosphorous-containing compound is present in the composition at a level in the range of about 0.1 M to about 20 M.

10. The method of claim 8, wherein the phosphorous-containing compound comprises phosphoric acid, phosphorous acid, or a mixture thereof.

11. The method of claim 10, wherein the phosphorous-containing compound is phosphoric acid.

12. The method of claim 11, wherein the phosphoric acid is present in the composition at a level in the range of about 0.5 M to about 5 M.

13. The method of claim 8, wherein the nitric acid is present in the composition at a level in the range of about 0.3 M to about 1 M.

14. The method of claim 8, wherein the aqueous composition comprises a third acid, or precursor thereof.

15. The method of claim 14, wherein the third acid has a pH of less than about 3.5 in pure water.

16. The method of claim 15, wherein the third acid comprises sulfuric acid, hydrochloric acid, hydrofluoric acid, hydrobromic acid, hydriodic acid, perchloric acid, alkyl sulfonic acids, or a mixture of any of the foregoing.

17. The method of claim 15, wherein the third acid is present in the composition at a level which is no greater than about 1.2 M.

18. The method of claim 15, wherein the third acid is hydrochloric acid, or a precursor thereof.

19. The method of claim 1, wherein the casted substrate is immersed in a bath of the aqueous composition.

20. The method of claim 19, wherein the bath is maintained at a temperature in the range of about room temperature to about 100 degrees Celsius, while the casted substrate is immersed therein.

21. The method of claim 1, wherein the casted substrate comprises iron, cobalt, nickel, aluminum, chromium, titanium, or a mixture which includes any of the foregoing.

22. The method of claim 21, wherein the casted substrate comprises a superalloy material.

23. The method of claim 1, wherein the casted substrate is an airfoil.

24. The method of claim 1, wherein the metallic material comprises tin, iron, cobalt, nickel, aluminum, chromium, titanium or a combination thereof.

25. A method for removing a metallic substance from the surface of a casted substrate, comprising the step of immersing the casted substrate in an aqueous composition which comprises:
(a) about 0.05 M to about 5 M of an acid having the formula HₓAF₆, wherein A is selected from the group consisting of Si, Ge, Ti, Zr, Al, and Ga; and x is 1-6.
(b) about 0.1 M to about 20 M of a phosphorous-containing compound or mixture thereof; and
(c) about 0.3 M to about 1 M of hydrochloric acid or nitric acid.

26. The method of claim 25, wherein component (a) is H₂SiF₆ or H₂ZrF₆; component (b) is phosphoric acid; and component (c) is hydrochloric acid.

27. The method of claim 25, wherein the substrate is a portion of a gas turbine engine.

28. An aqueous composition for removing a metallic material from the surface of a casted substrate, comprising:
(a) about 0.05 M to about 5 M of an acid having the formula HₓAF₆, wherein A is selected from the group consisting of Si, Ge, Ti, Zr, Al, and Ga; and x is 1-6;
(b) about 0.1 M to about 1 M of a phosphorous-containing compound; and
(c) about 0.3 M to about 1 M of hydrochloric acid or nitric acid.

29. The composition of claim 28, further comprising at least one additive selected from the group consisting of inhibitors, dispersants, surfactants, chelating agents, wetting agents, deflocculants, stabilizers, anti-settling agents, reducing agents, and anti-foam agents.

30. An aqueous composition for removing a metallic material from the surface of a casted substrate, comprising:
(a) about 0.05 M to about 5 M of an acid having the formula HₓAF₆, wherein A is selected from the group consisting of Si, Ge, Ti, Zr, Al, and Ga; and x is 1-6; and
(b) about 0.3 M to about 1 M of nitric acid.
